(19) United States
(12) Patent Application Publication
(10) Pub. No.: US 2010/0122123 A1
(43) Pub. Date: May 13, 2010

(54) METHOD FOR GUARANTEEING CONSISTENCY OF FUNCTIONAL PARTS ACROSS A SOFTWARE INSTALLATION IN A COMPUTER

(75) Inventors: Simon David BLUCK, Eastleigh (GB); Jason Colin EDMEADES, Hampshire (GB); Gary Patrick LONGERSTAEY, Hampshire (GB); Stuart Jeffrey REECE, Hampshire (GB)

Correspondence Address: Locke Lord Bissell & Liddell LLP;Attn: IP Docketing, Three World Financial Center, New York, NY, 10281-2101, US

(73) Assignee: INTERNATIONAL BUSINESS MACHINES CORPORATION, Armonk, NY (US)

(21) Appl. No.: 12/268,021

(22) Filed: Nov. 10, 2008

(51) Int. Cl. G06F 11/07

(52) U.S. Cl. 714/49; 714/E11.024

(57) ABSTRACT

A method for guaranteeing consistency of functional parts across a software installation in a computer that is platform and language independent. Specifically, each software installation will contain a part, for example a DLL that exports a function or variable, which is available to other parts in the installation. All other parts in the installation, for example, executable files and other DLLs, will reference the exported resource. The name of the exported resource should evoke a particular software level and be specific to the software installation it belongs to. All other software installations on the same computer will follow this practice. Thus, all parts in a software installation will effectively reference a software level (via an exported resource). When the multiple parts of software are loaded into computer memory prior to execution of the software, the operating system will attempt to resolve references to the exported resource. If a software part has been modified such that it refers to an inconsistent export resource, the operating system will produce an error at software load time, immediately identifying the inconsistent part.

### FIELD OF DISCLOSURE

The disclosure relates to installation of software on computer systems.

### BACKGROUND

Computer software applications are often composed of numerous subparts, each comprising many modules or files. It is common for individual modules to be continually updated and released as new versions. Of course, it is generally expected that when newly updated modules are installed and software is updated to a higher level, it remains functional and compatible with other software installed on the computer.

However, software with inconsistent levels among its component parts can occur. This can be the result of, for example: incomplete installations of full product maintenance or upgrades, applying fixes of the wrong level to software already installed on a system, and picking up modules from unexpected places (for example, perhaps some back level module exists as a result of a misconfiguration on a user's system).

The dilemmas associated with having inconsistent software installations are many. At the simplest level, the software may not run at all. For example, the inconsistent software component may have a function expecting completely different parameters than those being supplied by another component that calls and depends upon this function. Thus the inconsistency may be discovered when a runtime failure occurs. More insidious failures may be harder to identify. The software may appear to run normally but in fact produce erroneous results, without reporting any error whatsoever. In either case, the resultant failures are typically unexpected and unpredictable in nature.

Current techniques for identifying inconsistent software installations include, for example, discovering an inconsistency after a failure. However, the program has already run in this case, and also a nontrivial amount of work is required to spot the problem. This could entail capturing and analyzing a product trace, a review of change management logs, or a painstaking comparison of the current software state with a known good installation.

Various mechanisms exist to deal with inconsistent software installations. They are however either limited to a single platform or are language specific. Examples include the Java programming language's OSGi framework and Microsoft's .NET.

OSGi is a framework that requires software to be organized around “bundles.” Each bundle contains a “manifest file” having all the information about the bundle. It is the bundle and specific code contained within that is responsible for component dependency management activities. However, OSGi is specific to Java and built on the Java Virtual Machine.

The .NET framework advocates several basic principles to avoid component versioning problems: (1) self-describing applications; (2) recording and enforcing version information; (3) remembering the “last known good” set of components—including their versions—that worked together; (4) “side-by-side components”—allowing multiple versions of a component to be installed and running; and (5) “application isolation”—applications that cannot be affected by changes made to the machine on behalf of other applications. .NET is limited to Microsoft centric systems only.

### SUMMARY

The present disclosure relates to a method for guaranteeing consistency of functional parts across a software installation in a computer, that is also platform and language independent. Specifically, each software installation will contain a component part, for example a DLL that exports a function or variable, which is available to other parts in the installation. All other parts in the installation, for example, executable files and other DLLs, will reference the exported resource. The name of the exported resource should evoke a particular software level and be specific to the software installation it belongs to. All other software installations on the same computer will follow this practice. Thus, all parts in a software installation will effectively reference a software level (via an exported resource). When multiple parts of software are loaded into computer memory prior to execution of the software, the operating system will attempt to resolve references to the exported resource. If a software part has been modified such that it refers to an inconsistent export resource, the operating system will produce an error at software load time, immediately identifying the inconsistent part.

One exemplary embodiment involves a method for guaranteeing consistency of functional parts across a software installation in a computer comprising exporting a resource from a shared dynamic linked library of a software installation on a computer, wherein the software installation comprises a plurality of objects, wherein the objects comprise dynamic linked libraries and wherein the resource name identifies a current software level; referencing the resource from each object associated with the software program; loading the software program into a memory in the computer; and generating a dynamic linking error in the computer's operating system at the time of the software loading if an object associated with the software installation has been modified such that it references a resource identifying a different software level.

### BRIEF DESCRIPTION OF THE DRAWINGS

FIG. 1 is a diagram of a first software installation, configured as described in this disclosure.

FIG. 2 is a diagram of a second software installation, configured as described in this disclosure.

FIG. 3 is a diagram of the result of interaction of the first and second software installations shown in FIGS. 1 and 2 on the same computer.

FIG. 4 is a diagram of the state of the first software installation originally shown in FIG. 1, as affected by the second software installation.

### DETAILED DESCRIPTION

This disclosure addresses running inconsistent levels of software on a computer system, by identifying incompatible software versions, reporting incompatibilities and preventing incompatible versions from running. As will be explained below the method described provides a cross-library, cross-platform, cross-language solution.

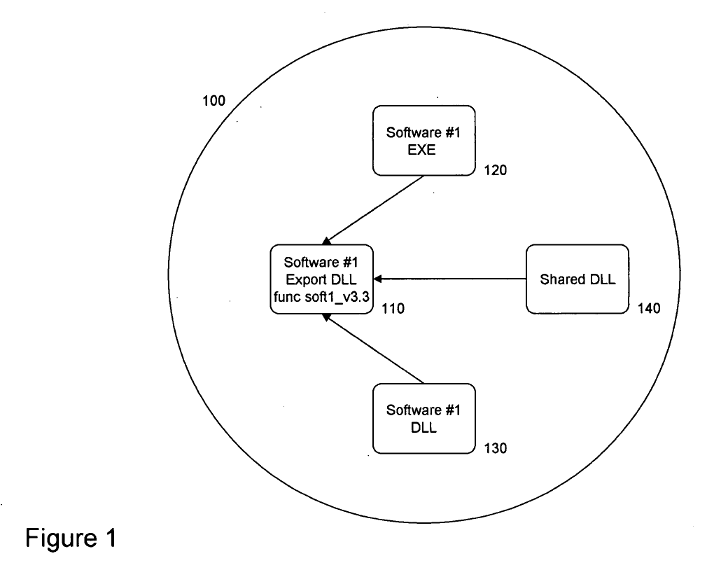

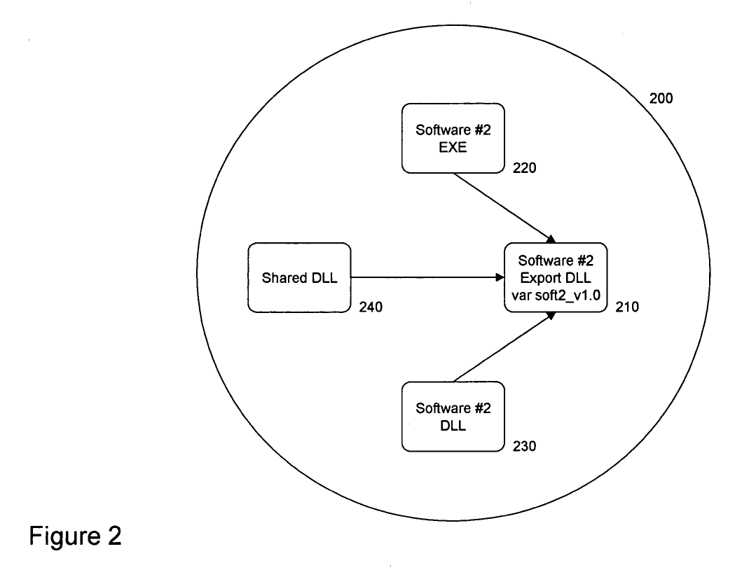

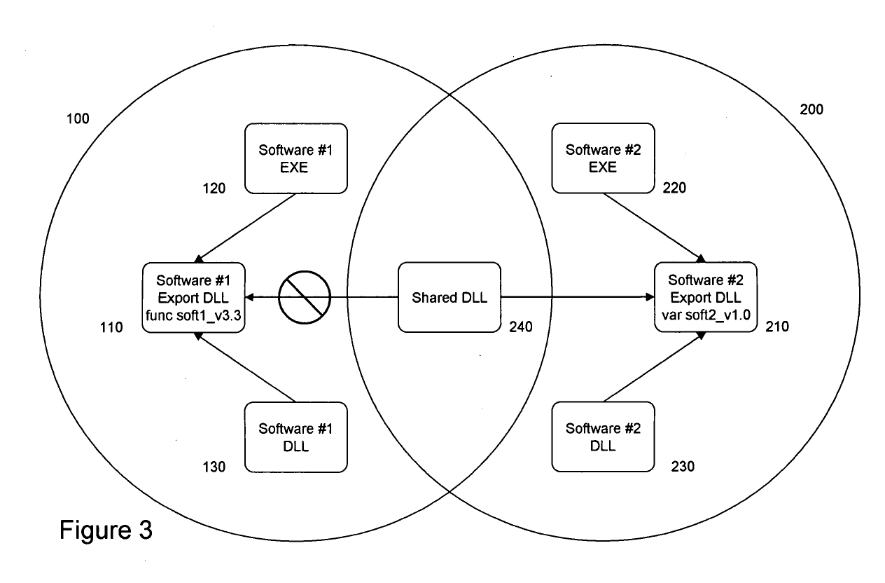

FIG. 1 is a diagram of a first software installation (100), configured as described in this disclosure. Software installation (100) consists of four subparts, a Export DLL (110), an executable (120), a DLL (130) and a “shared” DLL (140). Note that in the context of FIG. 1, standing alone, the designation that the DLL (140) is “shared” is not readily meaningful. The importance of this label will be explained in the discussion of FIGS. 2 and 3, below.

The Export DLL (110) contains a named export function, in this example, “soft1_v3.3.” Here, the name of the function has chosen to provide additional information (the software it is associated with as well as the version level). This information could be useful to determine a cause of software failure. Note that the export function need not have any underlying functionality or code. Its only role is to be referenced by other components in the software.

Every part in the first software installation (100) which is required to be consistent then references this function from the Export DLL (110). Depending on the software language, the reference can be either manual/explicit, or automatic. In the case of the ‘C’ programming language, reference to the export by a particular object can be automatically achieved by changes in the scripts used to build the software. For example, when executables are built from the original source code, an object requiring the export should be built into it, and the executable should also be linked with the object providing the export. This is advantageous since no changes need be made to the original source code. Thus in an automatic case, like the ‘C’ example, the impact on the build system to implement the software is minor. An example of a manual approach would be where the original source code is explicitly modified to establish dependencies on an export. Thus, regardless of the technique, the parts (120,130,140) of the first software installation (100) all will reference the function from the Export DLL (110).

FIG. 2 is a diagram of a second software installation (200), configured as described in this disclosure. In this example, the general composition of the second software installation (200) is substantially similar to the first software installation (100), though this is not required. The second software installation (200) also consists of four subparts, a Export DLL (210), an executable (220), a DLL (230) and a “shared” DLL (240). The Export DLL (210) contains a named export variable, in this example, “soft2_v1.0.”

FIG. 3 is a diagram of the result of interaction of the first and second software installations shown in FIGS. 1 and 2 on the same computer. The shared DLLs of FIG. 1 and FIG. 2 (140 and 240) are parts with a common name, as between the first software installation (100) and the second software installation (200). Both the first software installation (100) and second software installation (200) expect to make use of part with this name. However, there is no guarantee that shared DLL (140) of the first software installation (100) has the same functionality as the shared DLL (240) of the second software installation (200). In the most typical case, one application will install a new version of the shared component that is not backward compatible with the version already on the machine. Although the application that has just been installed works fine, existing applications that depended on a previous version of the shared component might no longer work. Thus a problem can arise if a shared DLL is overwritten with a version that is inconsistent.

Suppose that the first software installation of FIG. 1 (100) is initially installed on a computer system. Accordingly, shared DLL (140) would initially reference the function exported by DLL Export (110) of the first software installation (100). If the second software installation of FIG. 2 (200) were to be subsequently installed on the same computer, part of its installation process would include installing its own version of the shared DLL (240). If the shared DLL (140) of the first software installation (100) is thus overwritten in this manner as shown in FIG. 3, the end result is that the only shared DLL in the computer will be the version (240) consistent with the second software installation (200). This version of the shared DLL (240) references the export variable of the second software installation's DLL Export (210) rather the function offered by the first software installation (100)'s DLL Export (110).

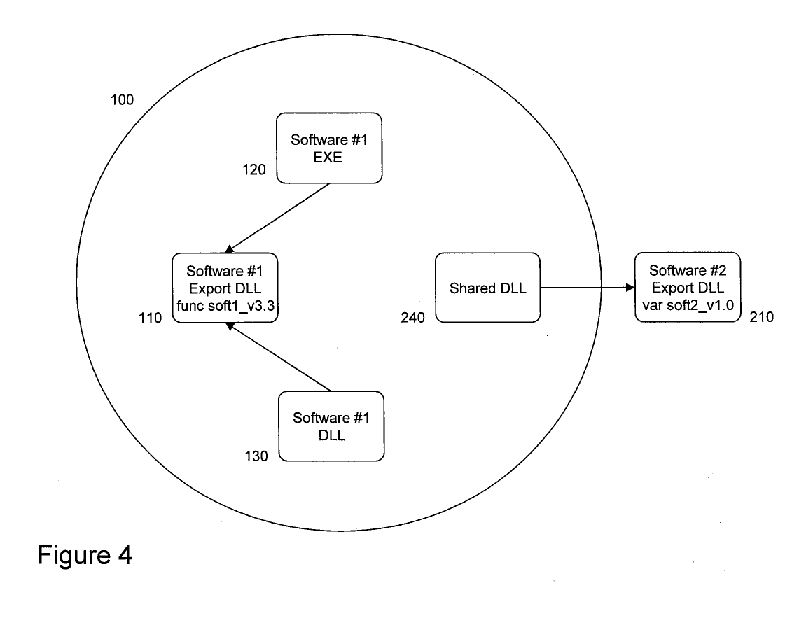

When a user attempts to run the first software installation (100), its various components are loaded into the computer's memory. As with all computer platforms that support dynamic loading of runtime components, name resolution of the dependencies among the software's various components will occur then. Referring back to FIG. 4, the components that the first software installation (100) knows to comprise itself include the DLL export (110), EXE (120), DLL (130) and a “shared DLL.” However the shared DLL (140) originally belonging to the first software installation shown in FIG. 1 (100) has been overwritten at this point by another version (240).

As the EXE (120) and DLL (130) are loaded into memory, the operating system will resolve their dependencies. Both of these component parts reference by name the function “soft1_v3.3,” which is provided by DLL export (110). As DLL export (110) is also a component part comprising the first software installation (100) that should be loaded into memory, and no error condition will occur with regard to the loading of EXE (120) and DLL (130).

When shared DLL (240) is loaded into memory, the operating system will attempt to resolve its dependency of the variable “soft2_v1.0” from the DLL Export (210) of Software #2 (200). However, the DLL export (210) of the second software installation (200) is not a component that is loaded into memory for the operation of the first software installation (100), since it is clearly not one of the components that comprise the first software installation. Accordingly, the operating system will generate an error message for the user. The error may indicate for example that variable “soft2_v1.0” referenced by the shared DLL (240) could not be resolved. Thus the content of the error message may inform the user which components are inconsistent and why (in this example, overwritten by “soft2_v1.0”). This will terminate the loading of the first software installation (100) immediately.

All that is needed by the method explained by FIGS. 1-4 is that either the computer language or operating system must support the dynamic loading of shared parts. What is utilized is a very basic and common mechanism used across all platforms which support dynamic loading of runtime components. Since name resolution has to occur on all of these, a named entry point can be used to enforce consistency without requiring any platform or language changes. In addition, most non-Java languages compile to operating system level bytecodes in shared libraries, and allow control of the entry points exported from the shared libraries. Hence the method would work for even a COBOL program calling a ‘C’ program, or PL/I calling C++, for example. Thus the method is not limited to a single platform or software language.

This method may also be extended to protect component sub-systems or overlapping aspects of a software product. This would be achieved straightforwardly by using different export functions for each sub-system or aspect. For example, if a piece of software were componentized and each component was on a separate maintenance schedule, there may be a versioning DLL for each component, each versioning DLL exporting a different function. The export functions would be referenced as needed by the appropriate component.

Therefore the method for guaranteeing consistency in a software installation described herein offers many advantages, including: (1) avoidance of an inconsistent running state; (2) preventing data corruption which can be caused by mixed levels; (3) enforcing consistency by operating systems or language; (4) reducing or eliminating skill required to identify problem when it occurs; (5) identifying a problem directly after the application of the inconsistent part(s); (6) supporting most languages and operating systems; (7) minimizing impact to software building infrastructure; and (6) implementability with no source code changes.

It will be appreciated by persons skilled in the art that the present disclosure is not limited to what has been particularly shown and described hereinabove. Rather, the scope of the present disclosure is defined by the claims which follow. It should further be understood that the above description is only representative of illustrative examples of embodiments. For the reader's convenience, the above description has focused on a representative sample of possible embodiments, a sample that teaches the principles of the present disclosure. Other embodiments may result from a different combination of portions of different embodiments.

The description has not attempted to exhaustively enumerate all possible variations. The alternate embodiments may not have been presented for a specific portion of the disclosure, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent.

1. A method for guaranteeing consistency of functional parts across a software installation in a computer comprising:
exporting a resource from a shared dynamic linked library when performing a software installation on a computer,
wherein the software installation comprises a plurality of objects,
wherein the plurality of objects comprise dynamic linked libraries and
wherein a resource name identifies a current software level;
referencing the resource from each object associated with a software program;
loading the software program into a memory in the computer; and
generating a dynamic linking error in the computer's operating system at the time of the software program loading if an object associated with the software installation has been modified such that it references a resource having a resource name identifying a different software level.
